(19) United States
(12) Patent Application Publication
(10) Pub. No.: US 2016/0173008 A1
(43) Pub. Date: Jun. 16, 2016

(54) SYSTEM AND METHOD FOR SOFT STARTING AND STOPPING OF A MOTOR

(71) Applicant: Solcon Industries Ltd., Yoqneam lllit (IL)

(72) Inventor: Yoram WALTUCH, Haifa (IL)

(21) Appl. No.: 14/567,592

(22) Filed: Dec. 11, 2014

(51) Int. Cl. H02P 1/24; H02P 6/20; H02P 27/06; H02P 3/18

(52) U.S. Cl. CPC H02P 1/24; H02P 3/18; H02P 6/20; H02P 27/06

(57) ABSTRACT

A soft starter device generates an output voltage of variable amplitude, frequency and phase. An output switch connects the soft starter device to a motor. A bypass switch connects the motor to a line voltage. A controller is configured operate the soft starter device to generate an output voltage that is synchronized with the line voltage. The bypass or output switch may be activated to open or close at an activation time, and a delay time between the activation time and a contact time when the switch opens or closes may be measured. The measured delay time may be utilized to update a value of a representative delay time for the switch. The representative delay time may be utilized to predict a contact time for the switch, or to select an activation time based on a target contact time for opening or closing the switch.

### FIELD OF THE INVENTION

The present invention relates to motor control. More particularly, the present invention relates to a system and method for soft starting and stopping of a motor.

### BACKGROUND OF THE INVENTION

Many devices and systems that employ electric motors benefit from inclusion of a soft starter. The soft starter enables gradual starting of the motor to its working speed and gradual slowing of the motor when being turned off. Use of the soft starter may reduce or eliminate mechanical and electrodynamic stress or shock to components of the system. A soft starter may include mechanical components (e.g., a clutch) or electronic components (e.g., star/delta, autotransformer, or other source of variable power, voltage, current, or frequency).

### SUMMARY OF THE INVENTION

There is thus provided, in accordance with an embodiment of the present invention, a system including: a soft starter device to generate an output voltage of variable amplitude, frequency and phase; an output switch to connect the soft starter device to a motor and to disconnect the soft starter device from the motor; a bypass switch to connect the motor to a line voltage and to disconnect the motor from the line voltage; and a controller configured to: operate the soft starter device to generate the output voltage such that the output voltage is synchronized with the line voltage; activate the bypass switch to open or close at a bypass activation time; measure a bypass delay time between the bypass activation time and a bypass contact time when the bypass switch opens or closes; activate the output switch to open or close at an output activation time; measure an output delay time between the output activation time and an output contact time when the output switch opens or closes; utilize the measured bypass delay time to update a value of a representative bypass delay time for opening or closing the bypass switch; utilize the representative bypass delay time to predict a contact time for the bypass switch when the bypass switch is activated at the bypass activation time, or to select a bypass activation time based on a target bypass contact time for opening or closing the bypass switch; utilize the measured output delay time to update a value of a representative output delay time for opening or closing the output switch; and utilize the representative output delay time to predict a contact time for the output switch when the output switch is activated at the output activation time, or to select a output activation time based on a target output contact time for opening or closing the output switch.

Furthermore, in accordance with an embodiment of the present invention, the soft starter device includes a three-level neutral point clamped (NPC) inverter.

Furthermore, in accordance with an embodiment of the present invention, the controller is configured to operate the soft starter device to concurrently vary the amplitude and frequency of the output voltage by application of v/f scalar control, field oriented control, or direct torque control.

Furthermore, in accordance with an embodiment of the present invention, the soft starter device includes a rectifier bridge that is configured to convert three-phase voltage input into a transformerless six-pulse rectified output.

Furthermore, in accordance with an embodiment of the present invention, the controller is configured to select the bypass activation time such that the target bypass contact time is within a maximum time interval of the predicted output contact time, or to select the output activation time such that the target output contact time is within the maximum time interval of the predicted bypass contact time.

Furthermore, in accordance with an embodiment of the present invention, the output switch or the bypass switch includes an auxiliary circuit with an auxiliary switch that is coupled to that switch, and wherein the controller is configured to measure the contact time of that switch by monitoring operation of the auxiliary circuit.

Furthermore, in accordance with an embodiment of the present invention, the controller is configured to modify the representative delay time for the output switch or the bypass switch by calculating a weighted average of the measured delay time and a current value of the representative delay time for that switch.

Furthermore, in accordance with an embodiment of the present invention, the controller is configured to calculate an initial value of the representative delay time for the output switch or the bypass switch on the basis of offline operation of that switch.

Furthermore, in accordance with an embodiment of the present invention, a component of the soft starter device is in thermal contact with a naturally cooled heat sink

Furthermore, in accordance with an embodiment of the present invention, the controller is configured to adjust a current or voltage gain.

Furthermore, in accordance with an embodiment of the present invention, the controller is configured to apply a voltage to a gate terminal of an insulated gate bipolar transistor (IGBT) to operate the soft starter device.

There is further provided, in accordance with an embodiment of the present invention, a method of starting a motor, the method including: increasing over a period of time an amplitude and frequency of an output voltage that is generated by a soft starter device and that is applied to the motor and adjusting a phase of the output voltage such that the output voltage is substantially synchronized with a line voltage; activating a bypass switch at a bypass activation time to close the bypass switch to connect the motor to the line voltage, concurrently measuring a bypass delay time between the bypass activation time and a bypass contact time of the closing of the bypass switch; predicting a predicted bypass contact time for the closing of the bypass switch based on the bypass activation time and a representative bypass delay time that is calculated on the basis of previous operation of the bypass switch; calculating an output activation time to open an output switch such that a target output contact time for the opening of the output switch is within a maximum time interval of the predicted bypass contact time, the calculation of the output activation time being based on the target output contact time and a representative output delay time that is calculated on the basis of previous operation of the output switch; activating the output switch at the calculated output activation time to open the output switch to disconnect the motor from the soft starter device, concurrently with measuring an output delay time between the output activation time and an output contact time of the opening of the output switch; and updating the value of the representative bypass delay time on the basis of the measured bypass delay time, and the value of the representative output delay time on the basis of the measured output delay time.

Furthermore, in accordance with an embodiment of the present invention, increasing the amplitude and frequency includes increasing the amplitude and frequency by applying v/f scalar control, field oriented control, or direct torque control

Furthermore, in accordance with an embodiment of the present invention, updating the value of the representative delay time for the bypass switch or for the output switch includes calculating a weighted average of the measured delay time and the representative delay time for that switch.

Furthermore, in accordance with an embodiment of the present invention, the method includes calculating an initial value of the representative delay time for the output switch or the bypass switch on the basis of offline operation of that switch.

Furthermore, in accordance with an embodiment of the present invention, the method includes stopping generation of the output voltage concurrently with the closing of the bypass switch.

There is further provided, in accordance with an embodiment of the present invention, a method of stopping a motor that is connected to a line voltage, the method including: operating a soft starter device to generate an output voltage that is synchronized with the line voltage; activating an output switch at an output activation time to close the output switch to connect the motor to the output voltage, concurrently measuring an output delay time between the output activation time and an output contact time of closing the bypass switch; predicting a predicted output contact time for the closing of the output switch based on the output activation time and a representative output delay time that is calculated on the basis of previous operation of the output switch; calculating a bypass activation time to open a bypass switch such that a target bypass contact time for the opening of the bypass switch is within a maximum time interval of the predicted output contact time, the calculation of the bypass activation time being based on the target bypass contact time and a representative bypass delay time that is calculated on the basis of previous operation of the bypass switch; activating the bypass switch at the calculated bypass activation time to open the bypass switch to disconnect the motor from the line voltage, concurrently with measuring a bypass delay time between the bypass activation time and a bypass contact time of the opening of the bypass switch; operating the soft starter device to decrease to a target voltage over a period of time the amplitude and frequency of the output voltage; and updating the value of the representative output delay time on the basis of the measured output delay time, and the value of the representative bypass delay time on the basis of the measured bypass delay time.

Furthermore, in accordance with an embodiment of the present invention, the target voltage is zero.

Furthermore, in accordance with an embodiment of the present invention, updating the value of the representative delay time for the bypass switch or for the output switch includes calculating a weighted average of the measured delay time and the representative delay time for that switch.

### BRIEF DESCRIPTION OF THE DRAWINGS

In order for the present invention, to be better understood and for its practical applications to be appreciated, the following Figures are provided and referenced hereafter. It should be noted that the Figures are given as examples only and in no way limit the scope of the invention. Like components are denoted by like reference numerals.

FIG. 1A schematically illustrates a system that incorporates a soft starter device in accordance with an embodiment of the present invention.

FIG. 1B schematically illustrates details of the soft starter device of the system shown in FIG. 1A.

FIG. 1C schematically illustrates a composite switch of the system shown in FIG. 1A.

FIG. 2 is a schematic diagram of a controller of the system shown in FIG. 1A.

FIG. 3 is a flowchart depicting a method for motor startup with contactor learning, in accordance with an embodiment of the present invention.

FIG. 4 is a flowchart depicting a method for motor stopping with contactor learning, in accordance with an embodiment of the present invention.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, us of the conjunction “or” as used herein is to be understood as inclusive (any or all of the stated options).

In accordance with an embodiment of the present invention, a soft starter device for gradual starting of a motor is configured to gradually increase or decrease the speed of a motor until the operating speed of the motor is attained. For example, in some cases, the speed of the motor may increased to its rated speed over a period of about 20 seconds to about 25 seconds. The startup time may be different for different motors or applications. The soft starter device is connected to a line voltage via an input switch in the form of a line contactor or breaker and to the motor by an output switch or contactor. When the line contactor is closed, the soft starter device is connected to the line voltage. For example, the line voltage may be a three-phase line voltage. The line voltage may be in the medium voltage range (e.g., from 1 kV to 20 kV), or a higher voltage range. Any such voltage range is herein referred to a high or medium voltage, while a lower voltage is herein referred to as low voltage.

The soft starter device is configured to concurrently increase a voltage and frequency of a voltage that is applied to the motor from an initial state of no applied voltage to a final condition. For example, the soft starter device may include an inverter for converting an alternating current (AC) line voltage to an approximation with direct current (DC) pulses of an AC signal that is characterized by one or more of an amplitude, frequency, or phase that is different from that of the line voltage. The DC pulses limited to a few voltage levels (e.g., three constant voltage levels having either positive, zero, or negative voltage). For example, the soft starter device may include a three-level neutral point clamped (NPC) inverter.

The inverter may include a transformerless 6-pulse inverter. Inclusion of a transformerless 6-pulse inverter may avoid the expense and complexity of a transformer (at the expense of increased harmonics), as would be required for 12-pulse inverter (or larger number of pulses).

The final condition may be identical to direct application of the line voltage to the motor. For example, at the final condition, the amplitude of the voltage that is applied to the motor matches the amplitude of the line voltage. Furthermore, at the final condition, the applied voltage is synchronized with the line voltage with regard to frequency and phase. As used herein, synchronizing refers to matching of two voltages with regard to all of amplitude, frequency, and phase.

When the final synchronized condition is attained, one or more bypass switches or contactors may be closed. The closed bypass contactors may connect the motor directly to the line voltage, bypassing the soft starter device. The output contactor may be opened concurrently with closing the bypass contactor. As used herein, concurrent operation of the bypass and output switches or contactors refers to operation within a maximum time interval (e.g., within a few milliseconds, such as ±10 ms, ±5 ms, or another maximum time interval) of one another.

In accordance with an embodiment of the present invention, the soft starter device is configured to measure a contactor response time of some or all of the switches or contactors that are closed or opened. In particular, response times may be measured for the bypass and output contactors. The learned response times may be utilized to improve accuracy of switching in the system. The measurement may include one or more of measuring a state of a switch (e.g., using an auxiliary switch), or measuring a change in voltage or current that results from closing or opening the switch. The measured response times may be utilized (e.g., by a controller of the soft starter device) in controlling timing of opening or closing the contactors. For example, a measured response time may be utilized in minimizing a delay between closing a bypass contactor and opening an output contactor.

In accordance with an embodiment of the present invention, the soft starter device may be passively or naturally cooled. As used herein, natural cooling refers to cooling that is based primarily on heat mass and on natural air convection, or air convection that is assisted by an external fan. Natural cooling does not include cooling that is based on strongly forced air cooling, internal fluid flow, or on immersion in a liquid. Natural cooling is possible since the soft starter device only operates during the relatively short time period during which the motor is being started or stopped. Once the motor is operating at a rated speed (and output of the soft starter is synchronized with the line voltage), a bypass switch is operated to connect the motor directly to the line voltage. Thus, during motor operation between starting and stopping, the motor is connected directly to the external AC power supply and little or no heat is generated by the soft starter. Thus, additional weight, space, complexity, and cost of an actively forced air or liquid cooling system (e.g., where a coolant fluid is forced through the heat sink, or if air is forced to flow via heat-sink fins) may be avoided.

In accordance with an embodiment of the present invention, the soft starter device may be provided with settings that enable low voltage testing of the device. For example, the soft starter device may be connected to a test motor in order to test operation of the soft starter device. The test motor may be much smaller than an operational motor that is to be operated on a regular basis by the soft starter device. The test motor may run at a voltage that is significantly lower (e.g., one or more orders of magnitude) than the voltage that would be required to operate the application motor (the motor that is to be operated by the soft starter device in regular operation). Such low-voltage testing of the soft starter device may be safer to both personnel and the system being tested. Various current and voltage gains are adjustable so as to enable operation of the test motor by the soft starter device without disabling protective functions of the soft starter device.

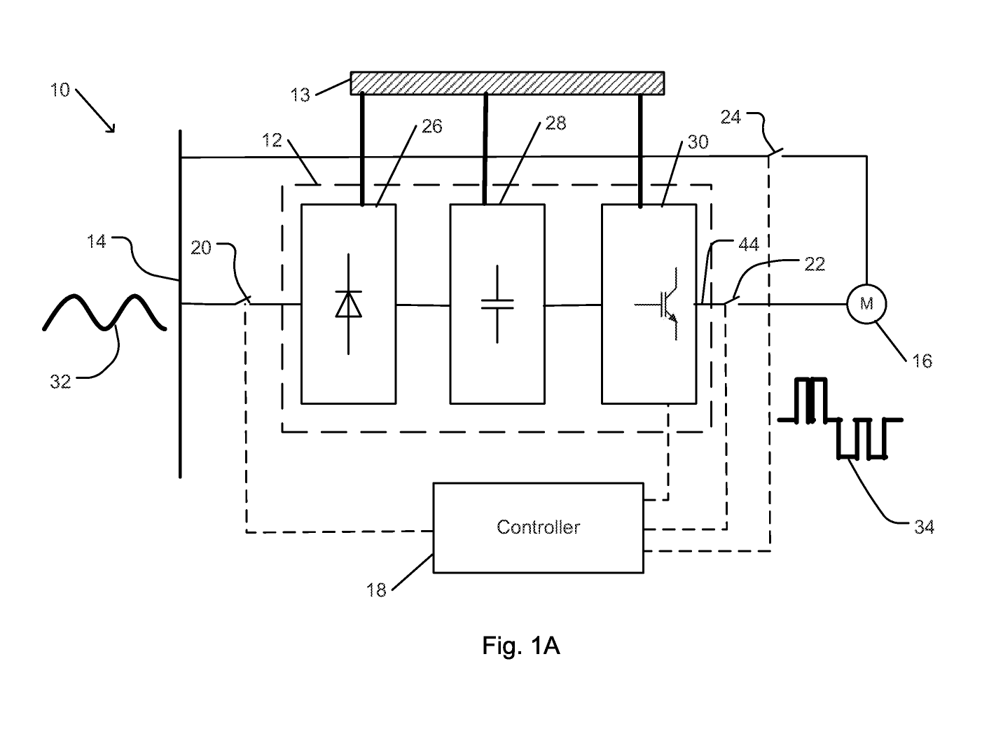

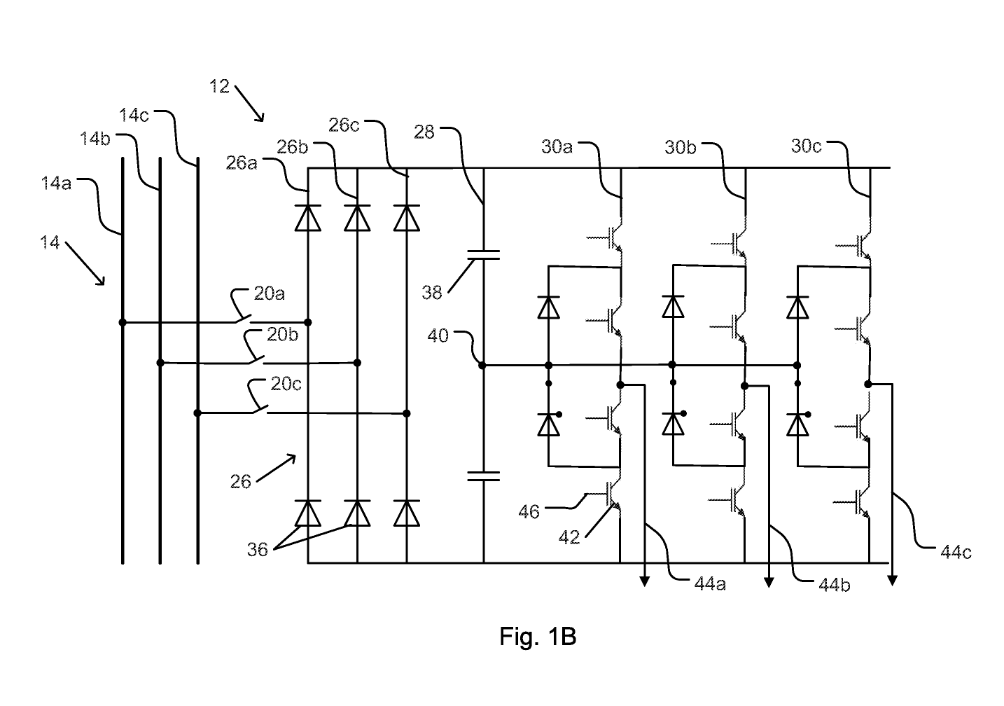

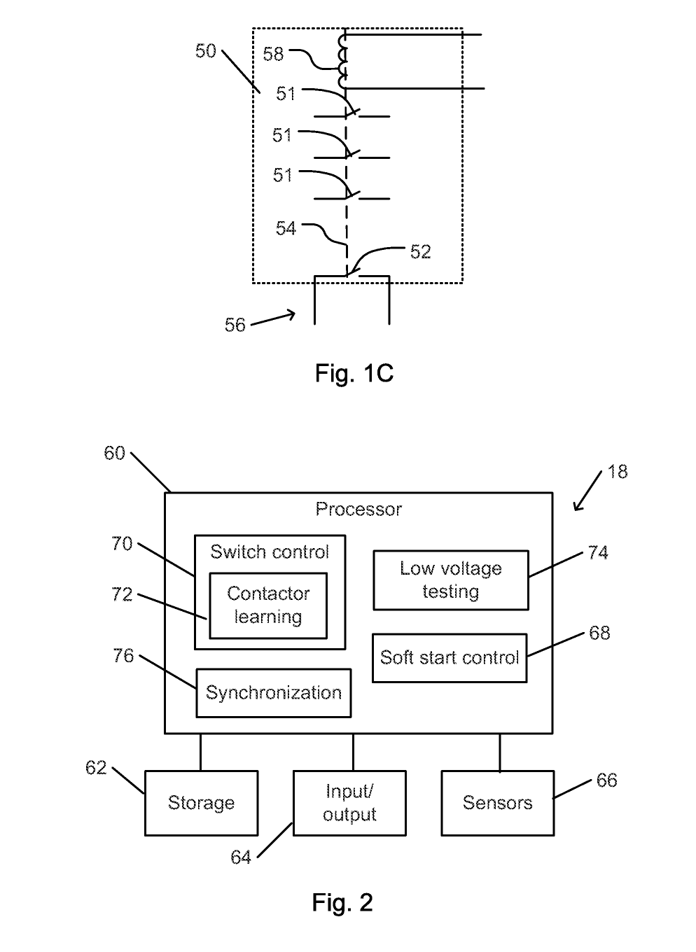

FIG. 1A schematically illustrates a system that incorporates a soft starter device in accordance with an embodiment of the present invention. FIG. 1B schematically illustrates details of the soft starter device of the system shown in FIG. 1A.

Motor system 10 includes soft starter device 12. Soft starter device 12 is connected to voltage supply line 14 when input switch 20 is closed. For example, input switch 20 may be a composite switch (described below). Input switch 20 may include a set of circuit breakers, contactors, relays, or other components that may be operated to connect soft starter device 12 to voltage supply line 14. Voltage supply line 14 may include a power mains, or output of a transformer. Voltage supply line 14 provides AC voltage 32. Typically, voltage supply line 14 includes three lines, voltage phase supply lines 14a, 14b, and 14c, each carrying a different phase of AC voltage. In this case, input switch 20 includes corresponding three component input switches 20a, 20b, and 20c, respectively. Typically, component input switches 20a, 20b, and 20c are mechanically coupled to operate in tandem.

Soft starter device 12 includes rectifier bridge 26. Rectifier bridge 26 typically includes component rectifier bridges 26a, 26b, and 26c, each connectable to the corresponding voltage phase supply line 14a, 14b, or 14c, respectively. Each of component rectifier bridges 26a, 26b, and 26c includes a set of diodes 36. Rectifier bridge 26 may be configured to convert three-phase voltage input into a six-pulse rectified output. When six-pulse output is acceptable (e.g., where an increased level of harmonics is tolerable), the additional weight, space, and cost of a phase-shifting transformer may be avoided. Where twelve-pulse output with lower harmonics is required, an input transformer may be included between input switch 20 and rectifier bridge 26.

Output of rectifier bridge 26 is fed into DC link 28. DC link 28 includes a DC capacitor bus with capacitors 38. DC voltage from neutral point 40 of DC link 28 is connected to inverter circuit 30.

Inverter circuit 30 may include an array of insulated gate bipolar transistors (IGBT) 42. Inverter circuit 30 typically includes a set of separate single phase inverter circuits 30a, 30b, and 30c. Inverter circuit 30 may be controlled by controller 18 to produce as series of pulses at two or more (e.g., three) voltage levels. Controller 18 may be connected to gate terminal 46 of each IGBT 42 to control output of that IGBT 42. For example, each of single phase inverter circuits 30a, 30b, and 30c may be operated by controller 18 to produce approximate AC voltages 34 with different phases. The series of pulses may approximate an AC voltage of a particular amplitude, frequency, and phase. For example, output of inverter circuit 30 may include three levels of output: a zero level, a single positive voltage level, and a single negative voltage level.

One or more components of soft starter 12, such as one or more components of rectifier bridge 26, DC link 28, or inverter circuit 30, may be thermally connected to (e.g., in direct or indirect thermal contact with) natural cooler 13 (with separate voltage levels requiring separate coolers). For example, natural cooler 13 may include one or more plates or blocks of a metal (e.g., aluminum, copper, or another metal), or another thermal mass or sink. Natural cooler 13 may be naturally or passively cooled, e.g., by enabling natural air convection, or may be cooled by an external fan that blows ambient air.

Output line 44, including output phase lines 44a, 44b, and 44c of single phase inverter circuits 30a, 30b, and 30c, respectively, may be connected to motor 16 via output switch 22. When the output of inverter circuit 30 is connected to motor 16, controller 18 may operate motor 16 with the output of inverter circuit 30.

Controller 18 may be configured to determine if output of inverter circuit 30 is synchronized with output of voltage supply line 14. For example, controller 18 may be configured to compare the amplitudes, frequencies, and phases of the outputs of inverter circuit 30 and voltage supply line 14. When the outputs of inverter circuit 30 and voltage supply line 14 are synchronized, powering of motor 16 may be transferred from soft starter device 12 to voltage supply line 14. In order to transfer the powering of motor 16, bypass switch 24 may be closed and output switch 22 may be opened.

One or more of input switch 20, output switch 22, and bypass switch 24 may include a composite switch. FIG. 1C schematically illustrates a composite switch of the system shown in FIG. 1A.

Composite switch 50 may represent the structure of one or more of input switch 20, output switch 22, and bypass switch 24. Composite switch 50 may include two or more (typically three, corresponding to the phases of an input or output three-phase AC voltage) component switches 51. Component switches may include circuit breakers, contactors, relays, or other switches. Component switches 51 may be mechanically linked to one another by mechanical link 54. Mechanical link 54 is operated by electromagnet coil 58. For example, mechanical link 54 may include a single bar, rod, transmission, axis, or other mechanical connection that concurrently opens or closes component switches 51. Controller 18 may cause a current to start or stop flowing through electromagnet coil 58 to operate mechanical link 54 to concurrently open or close component switches 51.

Mechanical link 54 may be configured to operate auxiliary switch 54 concurrently with component switches 51. Auxiliary switch 54 is configured to enable or disable electrical current in auxiliary circuit 56. For example, auxiliary circuit 56 may be configured to operate a voltage that is different from the voltage that is controlled by operation of component switches 51. Typically, the voltage in auxiliary circuit 56 is lower than the voltage of voltage supply line 14 or the maximum voltage output by soft starter device 12. Operation of auxiliary circuit 56 may enable monitoring of operation of component switches 51 when component switches 51 are disconnected from electrical power. For example, operation of auxiliary circuit 56 may enable monitoring of operation of component switches 51 during an initial phase of contactor learning, e.g., when soft starter device is disconnected from any power source, or prior to connection of soft starter device 12 to a medium voltage source.

In some cases, each component switch 51 may be separately operable. For example, each component switch 51 may be operated independently of the others by a separate electromagnet coil. If component switches 51 are separately operable, some or all of component switches 51 may be each separately linked to a separate auxiliary switch 54.

Each switch, such as each composite switch 50 or component switch 51, may be characterized by a delay time between an activation time at which the switch is activated (e.g., by issuing a command, e.g., by controller 18 to connect or disconnect power to electromagnet coil 58) to a contact time at which the contacts of component switches 51 are actually closed or opened (e.g., as determined by measurement of current flowing through auxiliary circuit 56 or through a circuit of which a component switch 51 is a component). As used herein, a contact time refers to a time at which contact is established (switch is closed) or broken (switch is opened) For example, a delay time may typically range from about 40 ms to about 200 ms. The delay time may be shorter than 40 ms or longer than 200 ms. Delay times for different switches may be differ from one another, and may change as each switch ages. A delay time for turning on a switch may be different from a delay time for turning off that same switch.

Controller 18 may be configured to operate each composite switch 50 (e.g., input switch 20, output switch 22, or bypass switch 24) such that the contact times of the various switches are synchronized with one another. For example, during startup, the contact time of closing of bypass switch 24 may be synchronized to occur within a maximum time interval of opening of output switch 22 (thus enabling a closed transition from soft starter device 12 to voltage supply line 14). In this manner, undesirable discontinuity in the voltage that is provided to motor 16 may be avoided.

FIG. 2 is a schematic diagram of a controller of the system shown in FIG. 1A.

Components of controller 18 may be included in a single housing, or may be include two or more separable units. For example, one or more separate units of controller 18 may be configured to intercommunicate via a wired or wireless connection.

Controller 18 includes processor 60. For example, processor 60 may include one or more processing units, e.g. of one or more computers or of a dedicated processing unit. Processor 60 may be configured to operate in accordance with programmed instructions, e.g., as stored in data storage device 62.

Processor 60 may communicate with input/output unit 64. Input/output unit 64 may include one or more input or output devices. Components of input/output unit 64 may be incorporated into controller 18 or may be external to controller 18. For example, input/output unit 64 may include an input or output device of a stationary or portable computer or computing device that may be connected to controller 18 via a wired or wireless connection. Input/output unit 64 may include a display screen, display panel, speaker or other sound-producing device, or another device capable of producing visible, audible, or tactile output. Input/output unit 64 may include one or more input devices. For example, an input device of input/output unit 64 may include keyboard, keypad, control, pointing device for enabling a user to input data or instructions for operation of processor 60.

Processor 60 may communicate with data storage device 62. Data storage device 62 may include one or more fixed or removable nonvolatile data storage devices. For example, data storage device 62 may include a computer readable medium for storing program instructions for operation of processor 60. It is noted that data storage device 62 may include a device that is remote from processor 60. In such cases data storage device 62 may include a storage device of a remote server storing programmed instructions for operation of processor 60. Data storage device 62 may be utilized to store data or parameters for use by processor 60 during operation, or results of operation of processor 60.

Processor 60 may communicate with sensors 66. For example, sensors 66 may be configured to measure properties of components of motor system 10. In particular, sensors 60 may be configured to measure voltage or current in one circuitry of motor system 10, of soft starter device 12, or input or output of soft starter device 12.

Processor 60 is configured to execute programmed instructions to enable controller 18 to control operation of motor system 10. For convenience of the description, various functionality of processor 60 when executing the programmed instructions may be considered as distributed among a plurality of modules. This division into modules should not be understood as implying a similar functional or other type of division of the programmed instructions.

Processor 60 is configured to execute soft start control module 68. Execution of soft start control module 68 enables processor 60 to operate soft starter device 12 to produce a gradually changing output voltage. For example, execution of soft start control module 68 may cause controller 18 to apply a particular sequence of gate voltages to each gate terminal 46 of each IGBT 42 of inverter circuit 30. Execution of soft start control module 68 may apply space vector pulse width modulation (SVPWM) to control inverter circuit 30. The result is a pulse width modulated series of pulses (e.g., a three-level series of pulses). The changing output voltage may be applied to motor 16 to gradually cause operation of motor 16 to gradually change from an initial state to a final state. For example, at startup, the initial state may include a complete stop and the final state may include rotation at an operating rotation rate. At shutdown, the initial state may include rotation at the operating rotation rate and the final state may include a complete cessation of rotation.

For example, execution of soft start control module 68 may enable controller 18 to operate soft starter device 12 to increase or decrease an amplitude and a frequency of the output voltage in tandem, e.g., such that the quotient or ratio of voltage amplitude to frequency is substantially constant. The constant quotient may result in a constant magnetic field within motor 16. The tandem variation of amplitude and frequency of the voltage may result in more efficient starting than operation of a starter that only varies voltage amplitude.

Execution of soft start control module 68 may include stopping operation of soft starter device 12 when measurements by sensors 66 are indicative of improper operation. For example, indications of improper operation may include a sensed current or voltage that is smaller than a minimum level or that is greater than a maximum level.

Execution of synchronization module 76 may compare output of soft starter device with the line voltage in voltage supply line 14. Execution of synchronization module 76 may compare the amplitude, frequency, and phase of the output voltage on each output phase line 44a, 44b, and 44c with the amplitude, frequency, and phase of a corresponding line voltage in the voltage phase supply line 14a, 14b, or 14c to which each output voltage is to be synchronized. For example, the comparison may compare a amplitude, frequency, and phase of a fundamental harmonic of the output voltage on each output phase line 44a, 44b, and 44c with the amplitude, frequency, and phase of the line voltage in the corresponding voltage phase supply line 14a, 14b, or 14c.

Execution of soft start control module 68 may cooperate with execution of synchronization module 76 to adjust the output voltages to be synchronized with the line voltages. For example, execution of soft start control module 68 in accordance with synchronization module 76 may apply SVPWM to synchronize the output voltages with the line voltages. Execution of synchronization module 76 may indicate when the corresponding voltages are synchronized.

Execution of switch control module 70 enables controlling switches of motor system 10. Such switches may include input switch 20, output switch 22, or bypass switch 24. The switches may be operated so as to enable efficiency of operation of motor system 10, and to inhibit or prevent premature degradation of components of motor system 10. For example, the switches may be operated such that motor 16 is operated by soft starter device 12 only during startup, shutdown, or changing rotation speed. During operation of soft starter device 12, input switch 20 and output switch 22 are closed and bypass switch 24 is opened. During the remainder of the time, such as operation of motor 16 at a constant rotation rate, motor 16 may be operated directly by power from voltage supply line 14. During this time, bypass switch 24 is closed, input switch 22 is opened and output switch 22 is opened.

Execution of switch control module 70 includes execution of contactor learning module 72. Execution of contactor learning module 72 enables learning of a delay time that characterizes each switch. For example, when a motor system 10 is initialized, or after a switch is replaced or its connections are modified, an initialization process may be performed. The initialization process may include initial contactor learning by repeated offline operation of each switch while measuring the delay time during each operation. During offline learning, no current or voltage is affected by operation of the switch. For example, offline learning may be performed by reading or sensing a switch contact position using an auxiliary switch and circuit. The initialization process may result in storing a representative (e.g., average, or other representative value) delay time for each switch on data storage device 62.

The accuracy of an initial value of the representative delay time may be further by operation (soft starting and stopping) at low voltage, during which the value of the representative delay time may be updated as described below.

During subsequent operation of the switches, e.g., after motor system 10 is connected to a voltage, contactor learning module 72 may continue to be executed in order to update the representative delay time for each switch. This subsequent contactor learning may be based on reading or sensing a contact position, e.g., via an auxiliary switch and circuit, on measuring changes in voltages and currents that result directly from operation of the switch, or both. Measuring a delay time by direct measurement of voltages and currents may be more reliable and accurate than a measuring operation of an auxiliary circuit. The continued updating of the representative delay time may enable correct operation of switch control module 70 as the switches age. For example, a weighted average between a newly measured delay time for a switch and the stored representative delay time for that switch may be performed. The result of the weighted average may be stored as the new representative delay time that is to be applied during subsequent operation of the switch. For example, a weighted average may be calculated as the sum of the produce of the newly measured delay time multiplied by a first factor (e.g., 0.01, or another factor) and the product of the stored representative delay time multiplied by a second factor (e.g., 0.99, or another factor that yields a value of one when added to the first factor).

Execution of switch control module 70 may utilize the stored representative delay time to predict a contact time of a switch when activating the switch at a selected activation time. The contact time may be predicted to be sum of the activation time and the delay time. For example, programmed instructions for switch control module 70 may indicate that different switches are to operate in a particular predetermined sequence. Such a sequence may include, for example, that a contact time for a switch is to occur within a predetermined time of another event, such as the contact time of another switch or another operation. Execution of switch control module 70 may utilize the stored representative delay time to ensure that the contact time for the switch occurs in accordance with the predetermined sequence.

Execution of low voltage testing module 74 may enable field testing of motor system 10 at a low voltage. For example, a soft start device 12 at an installed site may be to a low voltage motor instead of a high or medium voltage motor that is to be operated by motor system 10 after low voltage testing. During low voltage testing, motor system 10 (e.g., input switch 20 and bypass switch 24) may be connected to low voltage mains (e.g., a standard three-phase wall socket).

For example, field testing at low voltage, requiring fewer safety precautions than testing at higher voltage, may be simpler and faster than testing at a higher voltage. Furthermore, the risk of damage to components of motor system 10 in case of a fault or defect, or the risk of injury to personnel, is much smaller during low voltage testing than would be the risk at higher voltages. Low voltage testing may be performed during installation of motor system 10, or during maintenance or service of motor system 10. For example, low voltage testing may be used to safely test synchronization of bypass switch 24 with output switch 22.

Execution of low voltage testing module 74 may enable adjustment of one or more current or voltage gains (e.g., of one or more phases of the output power) or thresholds such that low voltage testing does not result in an error (e.g., under-current) that prevents operation of motor system 10. Adjustment of the gains and thresholds may also enable testing of various safety features (over-current) without risking damage to motor system 10. A gain may be adjusted by a user operating input/output unit 64 or automatically by testing module 74.

For example, a current gain for each phase may be separately set to one of 255 levels. The current gain may be increased in order to test or demonstrate an over-current, overload, or imbalance detection function.

A gain may be increased in order to simulate operation of a large motor by operating a small motor (e.g., without triggering an under-current detection). For example, if the motor system 10 is configured for a motor that is rated for 600 A, motor system 10 may be tested on a motor rated for 4 A by setting the current gain value to 150. The resulting tests may be performed as if 600 A motor is being used. The current gain may be set manually by a user or automatically.

A gain may be automatically adjusted as part of a calibration process to optimize an output current of soft starter device 12 to (e.g., a rating of) a particular motor 16.

Similarly, a voltage gain (e.g., an adjustable transformer) may be set to enable low-voltage output to a small motor when the system is operating as if providing high or medium voltage to a large motor.

Execution of low voltage testing module 74 may enable adjustment of a gain to demonstrate or test various functions during normal (e.g., medium or high voltage) operation. For example, a gain may be adjusted to test or demonstrate an over-current, under-current, overload, or other fault detection or protection functions. Setting different gains for each phase may enable testing imbalance or ground fault protections.

The gain may be automatically set so to allow best matching between soft starter device 12 and an actual load. For example, if soft starter device 12 is rated for a current of 400 A, and is connected to a small motor 16 rated for 40 A, an automatic gain adjustment may increase the current gain to enable the electronics to operate under conditions appropriate for the small motor.

Processor 60 may be configured to execute a method for motor startup with contactor learning.

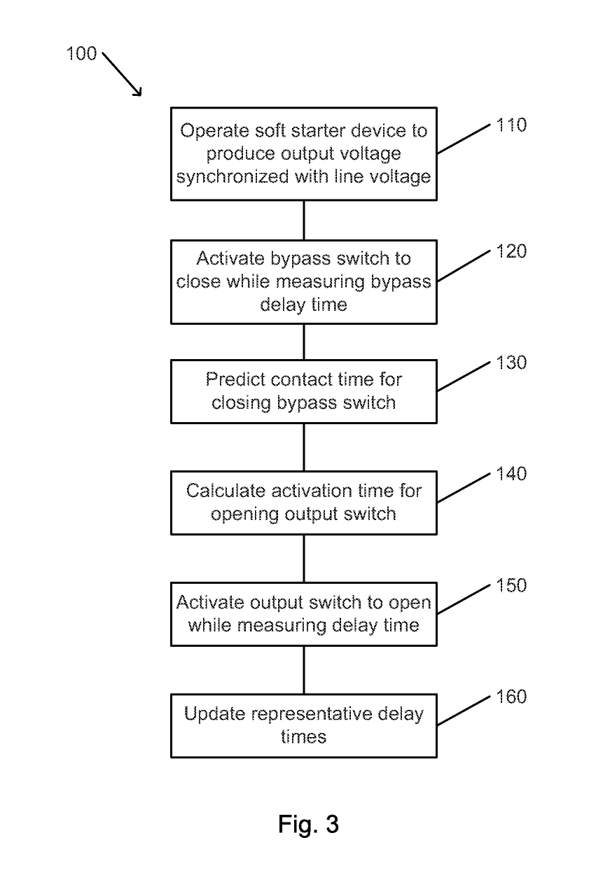

FIG. 3 is a flowchart depicting a method for motor startup with contactor learning, in accordance with an embodiment of the present invention.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Motor startup method 100 may be executed when a motor is not connected to an electrical power source. For example, the motor may be substantially at rest or may be rotating at reduced speed (e.g., after a power failure).

Motor startup method 100 may be executed by a processor of a controller of a motor system to control soft starting of a motor. Motor startup method 100 may be executed upon a request or command that is issued by a user that is operating an input device or switch, or operating a remote device that communicates with the controller via a wired or wireless (e.g., a serial link or other link). Motor startup method 100 may be executed automatically by a local or remote control system, e.g., when startup is indicated by a timer or by an application or program that is configured to determine times or parameters of operation of one or more motors.

An inverter circuit of a soft starter device is operated to automatically generate an output voltage signal that is applied to the motor and that is synchronized with the line voltage (block 110). The amplitude and frequency of the voltage signal are gradually increased over a period of time.

The period of time may be set to be several seconds, e.g., tens of seconds (e.g., about 20 seconds to 25 seconds) for some motors. The period of time be shorter or longer. For example, gate terminals of an IGBT array may be operated to generate a three-level pulse width modulated output that approximates a sine wave AC voltage. The amplitude and frequency may be increased in tandem such that the ratio of amplitude to frequency remains constant (application of V/f scalar control). Alternatively, the amplitude and frequency may be increased with another relationship between them. For example, a vector control method such as field oriented control, direct torque control, or another control method may be applied. The generated output voltage is applied to a motor to gradually increase the speed of rotation (or another motion) of the motor. When the amplitude and frequency have been increased to their final (e.g., their rated) values, e.g., the amplitude and frequency of the line voltage, the motor may be running at its rated speed. During this time, input and output switches of the soft starter device are closed, and a bypass switch is open.

When the amplitude and frequency of the generated voltage are increased (e.g., by SVPWM control of the IGBT array) to match the amplitude and frequency of a line voltage, the phase of the generated output voltage is automatically adjusted such that the generated voltage is synchronized (with respect to amplitude, frequency, and phase) with the line voltage.

When the generated voltage is synchronized with the line voltage, a bypass switch may activate to close while concurrently measuring the bypass delay time of closing the bypass switch (block 120). The bypass switch is activated to close at a bypass activation. The bypass switch closes at a bypass contact time for closing the bypass switch. Closing the bypass switch connects the motor directly to the line voltage. The bypass time delay may be measured by determining the activation time of the bypass switch (e.g., by determining when a close command is issued by a controller) and by measuring or sensing the bypass contact time (e.g., by measuring when current flows through a conductor that connects the line voltage to the motor). The time delay is utilized in contactor learning. An initial bypass delay time may have been previously measured by offline contactor learning operation of the switch (e.g., by measuring a response time of an auxiliary circuit when the bypass switch is disconnected, or is connected to a low voltage source).

A contact time for closing the bypass switch may be predicted (block 130). The predicted bypass contact time by be predicted on the basis of the bypass activation time and a representative bypass delay time that is calculated, or that was previously calculated and subsequently stored, on the basis of previous operation of the bypass switch (e.g., offline, or during previous operation of the system at medium voltage). For example, the predicted bypass contact time may be calculated by adding the representative bypass delay time to the bypass activation time.

In some cases, after closing the bypass switch, operation of the inverter circuit of the soft starter device is stopped, such that no output voltage is generated. For example, a gate voltage may no longer be applied to gate terminals of the IGBT array.

An activation time to activate the output switch to open may be calculated (block 140). The calculation is such that the output switch is predicted to open at a target output contact time that is selected to occur within a predetermined time interval of the predicted bypass contact time. The calculation of the output activation time is based on the target output contact time and a representative output delay time that is calculated, or that was previously calculated and subsequently stored, on the basis of previous operation of the output switch (e.g., offline, or during previous operation of the system at medium voltage). For example, the output activation time may be calculated to lead the target output contact time by a time interval that is substantially equal to the representative output delay time.

The maximum or allowed time interval range have a duration of a few milliseconds (e.g., ±10 ms, ±5 ms, or another time interval), or another suitable value.

At the calculated output activation time the output switch is activated to open to disconnect the motor from the soft starter device. Concurrently, an output delay time between the output activation time and an output contact time of the opening of the output switch is measured (block 150).

The output time delay may be measured by determining sensing the activation time of the output switch (e.g., the calculated output activation time or by determining the time at which a command to open the output switch is generated by a controller) and a contact time (e.g., by measuring a time of cessation of current flow through the output switch). The measured time delay is utilized in contactor learning for the output switch. An initial value of the representative delay time may have been calculated by offline contactor learning during offline operation of the output switch.

The input switch may also be opened. Opening the input switch may, by cutting off power to the soft starter device, further reduce energy consumption and increase the reliability of the soft starter device.

The stored representative delay times for closing the bypass switch and for opening the output switch may be updated on the basis of the measured delay times (block 160). The representative bypass delay time may be updated on the basis of the currently measured bypass delay time. The value of the representative output delay time may be updated on the basis of the currently measured output delay time. For example, the adjustment may include a weighted average of the previously stored representative delay time and the currently measured delay time.

Similarly, processor 60 may be configured to execute a method for motor stopping with contactor learning.

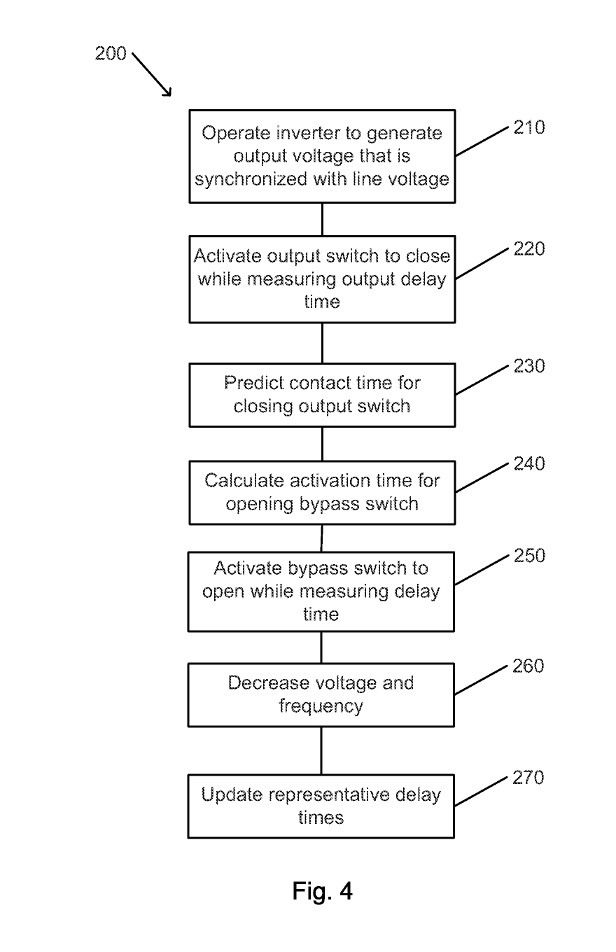

FIG. 4 is a flowchart depicting a method for motor stopping with contactor learning, in accordance with an embodiment of the present invention.

Motor stopping method 200 may be executed when a motor is running near to or at its rated speed, e.g., when connected to a line voltage via a closed bypass switch. Execution of motor stopping method 200 may stop operation of the motor.

Motor stopping method 200 may be typically executed by the same processor of a controller of a motor system that controls the soft startup of a motor. Motor stopping method 200 may be executed upon a request or command that is issued by a user that is operating a local or remote input device. Motor stopping method 200 may be executed automatically by a local or remote control system, e.g., when stopping is indicated by a timer or by an application or program that is configured to determine times or parameters of operation of one or more motors.

An inverter circuit of a soft starter device is operated to automatically generate an output voltage signal that is synchronized with the line voltage (block 210). For example, SVPWM gate signals of the IGBT array may be operated to generate a three-level pulse width modulated output that approximates a sine wave AC voltage. The amplitude, frequency, and phase of the output voltage are synchronized with that of the line voltage.

The output switch may be activated at an output activation time to close the output switch while concurrently measuring an output delay time between the output activation time and an output contact time of the closing of the bypass switch (block 220). The output switch may be activated to close when the generated voltage is synchronized (by amplitude, phase and frequency matching) with the line voltage. Closing the output switch connects the motor to the output voltage. The output time delay may be measured by determining an activation time of the output switch (e.g., determining a time at which a command to close the output switch is issued by a controller) and sensing a contact time (e.g., by sensing or measuring when current flows at a maximum rate through the output switch or through a conductor that connects the output voltage to the motor).

A predicted output contact time for the closing of the output switch is predicted (block 230). The prediction is based on the output activation time and a representative output delay time that is calculated, or that was previously calculated and subsequently stored, on the basis of previous operation of the output switch (e.g., offline, or during previous operation of the system at medium voltage). For example, the predicted output contact time may be calculated by adding the representative output delay time for closing the output switch to the output activation time.

A bypass activation time to activate the bypass switch to open may be calculated (block 240). The bypass activation time is calculated such that a target bypass contact time for the opening of the bypass switch is within a maximum time interval of the predicted output contact time. The calculation of the bypass activation time may be being based on the target bypass contact time and on a representative bypass delay time for opening the bypass switch. The representative bypass delay time may be calculated, or may have been previously calculated and subsequently stored, on the basis of previous operation of the bypass switch (e.g., offline, or during previous operation of the system at medium voltage). For example, the bypass activation time may be calculated by subtracting the representative bypass delay time for opening the bypass switch from the target bypass.

The bypass switch is activated at the calculated bypass activation time to open the bypass switch, concurrently with measuring a bypass delay time between the bypass activation time and a bypass contact time of the opening of the bypass switch (block 250). Opening the bypass switch disconnects the motor from the line voltage.

The maximum or allowed time interval have a duration of a few milliseconds (e.g., five milliseconds), or another suitable value.

After opening the bypass switch, the motor is no longer powered by the line voltage, but only by the output voltage of the soft starter device. For example, an activation time for the bypass switch may be calculated to lead the target bypass contact time by a time interval that is substantially equal to the representative bypass delay time. The time delay may be measured by determining an activation time of the bypass switch (e.g., a time at which a command to open the bypass switch is issued by a controller) and a bypass contact time (e.g., by measuring a time of cessation of current flow through the bypass switch).

The inverter circuit of the soft starter device is operated to automatically decrease the voltage amplitude and frequency (e.g., applying a V/f scalar, vector, direct torque, or other control method) of the generated output voltage signal of to zero or to another target level over a period of time (block 260). The decreasing output voltage is applied to the motor to gradually decrease the speed of rotation (or another motion) of the motor until the motor stops or is operating at a target rate.

The stored representative delay times for opening the bypass switch and for closing the output switch may be updated on the basis of the measured values (block 270). For example, the adjustment may include a weighted average of the previously stored representative delay time and the currently measured delay time.

Different embodiments are disclosed herein. Features of certain embodiments may be combined with features of other embodiments; thus certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A system comprising:
a soft starter device to generate an output voltage of variable amplitude, frequency and phase;
an output switch to connect the soft starter device to a motor and to disconnect the soft starter device from the motor;
a bypass switch to connect the motor to a line voltage and to disconnect the motor from the line voltage; and
a controller configured to:
operate the soft starter device to generate the output voltage such that the output voltage is synchronized with the line voltage;
activate the bypass switch to open or close at a bypass activation time;
measure a bypass delay time between the bypass activation time and a bypass contact time when the bypass switch opens or closes;
activate the output switch to open or close at an output activation time;
measure an output delay time between the output activation time and an output contact time when the output switch opens or closes;
utilize the measured bypass delay time to update a value of a representative bypass delay time for opening or closing the bypass switch;
utilize the representative bypass delay time to predict a contact time for the bypass switch when the bypass switch is activated at the bypass activation time, or to select a bypass activation time based on a target bypass contact time for opening or closing the bypass switch;
utilize the measured output delay time to update a value of a representative output delay time for opening or closing the output switch; and
utilize the representative output delay time to predict a contact time for the output switch when the output switch is activated at the output activation time, or to select a output activation time based on a target output contact time for opening or closing the output switch.

2. The system of claim 1, wherein the soft starter device comprises a three-level neutral point clamped (NPC) inverter.

3. The system of claim 1, wherein the controller is configured to operate the soft starter device to concurrently vary the amplitude and frequency of the output voltage by application of v/f scalar control, field oriented control, or direct torque control.

4. The system of claim 1, wherein the soft starter device comprises a rectifier bridge that is configured to convert three-phase voltage input into a transformerless six-pulse rectified output.

5. The system of claim 1, wherein the controller is configured to select the bypass activation time such that the target bypass contact time is within a maximum time interval of the predicted output contact time, or to select the output activation time such that the target output contact time is within the maximum time interval of the predicted bypass contact time.

6. The system of claim 1, wherein the output switch or the bypass switch comprises an auxiliary circuit with an auxiliary switch that is coupled to that switch, and wherein the controller is configured to measure the contact time of that switch by monitoring operation of the auxiliary circuit.

7. The system of claim 1, wherein the controller is configured to modify the representative delay time for the output switch or the bypass switch by calculating a weighted average of the measured delay time and a current value of the representative delay time for that switch.

8. The system of claim 1, wherein the controller is configured to calculate an initial value of the representative delay time for the output switch or the bypass switch on the basis of offline operation of that switch.

9. The system of claim 1, wherein a component of the soft starter device is in thermal contact with a naturally cooled heat sink

10. The system of claim 1, wherein the controller is configured to adjust a current or voltage gain.

11. The system of claim 1, wherein the controller is configured to apply a voltage to a gate terminal of an insulated gate bipolar transistor (IGBT) to operate the soft starter device.

12. A method of starting a motor, the method comprising:
increasing over a period of time an amplitude and frequency of an output voltage that is generated by a soft starter device and that is applied to the motor and adjusting a phase of the output voltage such that the output voltage is substantially synchronized with a line voltage;
activating a bypass switch at a bypass activation time to close the bypass switch to connect the motor to the line voltage, concurrently measuring a bypass delay time between the bypass activation time and a bypass contact time of the closing of the bypass switch;
predicting a predicted bypass contact time for the closing of the bypass switch based on the bypass activation time and a representative bypass delay time that is calculated on the basis of previous operation of the bypass switch;
calculating an output activation time to open an output switch such that a target output contact time for the opening of the output switch is within a maximum time interval of the predicted bypass contact time, the calculation of the output activation time being based on the target output contact time and a representative output delay time that is calculated on the basis of previous operation of the output switch;
activating the output switch at the calculated output activation time to open the output switch to disconnect the motor from the soft starter device, concurrently with measuring an output delay time between the output activation time and an output contact time of the opening of the output switch; and
updating the value of the representative bypass delay time on the basis of the measured bypass delay time, and the value of the representative output delay time on the basis of the measured output delay time.

13. The method of claim 12, wherein increasing the amplitude and frequency comprises increasing the amplitude and frequency by applying v/f scalar control, field oriented control, or direct torque control

14. The method of claim 12, wherein updating the value of the representative delay time for the bypass switch or for the output switch comprises calculating a weighted average of the measured delay time and the representative delay time for that switch.

15. The method of claim 12, comprising calculating an initial value of the representative delay time for the output switch or the bypass switch on the basis of offline operation of that switch.

16. The method of claim 12, comprising stopping generation of the output voltage concurrently with the closing of the bypass switch.

17. A method of stopping a motor that is connected to a line voltage, the method comprising:
operating a soft starter device to generate an output voltage that is synchronized with the line voltage;
activating an output switch at an output activation time to close the output switch to connect the motor to the output voltage, concurrently measuring an output delay time between the output activation time and an output contact time of closing the bypass switch;
predicting a predicted output contact time for the closing of the output switch based on the output activation time and a representative output delay time that is calculated on the basis of previous operation of the output switch;
calculating a bypass activation time to open a bypass switch such that a target bypass contact time for the opening of the bypass switch is within a maximum time interval of the predicted output contact time, the calculation of the bypass activation time being based on the target bypass contact time and a representative bypass delay time that is calculated on the basis of previous operation of the bypass switch;
activating the bypass switch at the calculated bypass activation time to open the bypass switch to disconnect the motor from the line voltage, concurrently with measuring a bypass delay time between the bypass activation time and a bypass contact time of the opening of the bypass switch;
operating the soft starter device to decrease to a target voltage over a period of time the amplitude and frequency of the output voltage; and
updating the value of the representative output delay time on the basis of the measured output delay time, and the value of the representative bypass delay time on the basis of the measured bypass delay time.

18. The method of claim 17, wherein the target voltage is zero.

19. The method of claim 17, wherein updating the value of the representative delay time for the bypass switch or for the output switch comprises calculating a weighted average of the measured delay time and the representative delay time for that switch.
